(19) United States
(12) Patent Application Publication
(10) Pub. No.: US 2014/0129927 A1
(43) Pub. Date: May 8, 2014

(54) PAGE BROWSING METHOD AND BROWSER

(71) Applicant: Tencent Technology (Shenzhen) Company Limited, Shenzhen (CN)

(72) Inventors: Meng GAO, Shenzhen (CN); Qilin Wang, Shenzhen (CN)

(73) Assignee: Tencent Technology (Shenzhen) Company Limited, Shenzhen (CN)

(21) Appl. No.: 14/142,523

(22) Filed: Dec. 27, 2013

Related U.S. Application Data
(63) Continuation of application No. PCT/CN2013/086109, filed on Oct. 29, 2013.

(30) Foreign Application Priority Data
Nov. 2, 2012 (CN) 201210433297.1

(51) Int. Cl. G06F 17/22

(52) U.S. Cl. CPC G06F 17/2247
USPC 715/234

(57) ABSTRACT

The present disclosure provides a page browsing method and a browser, the page browsing method comprising: loading page data; displaying a page in the browsing area of a browser interface; monitoring user events of the browser interface; and setting the address bar to hidden upon identifying a first action message at the time when the user is browsing the page content. The present disclosure effectively increases user's browsing area and maximizes the browsing area on the interface through automatic control of show/hide of the browser address bar without affecting user's usage, thereby enhancing user experience.

### CROSS-REFERENCE TO RELATED APPLICATIONS

This application is a continuation application of PCT Patent Application No. PCT/CN2013/086109, entitled “PAGE BROWSING METHOD AND BROWSER” filed on Oct. 29, 2013, which claims priority to a Chinese Patent Application No. 201210433297.1, filed on Nov. 2, 2012, both of which are incorporated by reference in their entireties.

### FIELD OF THE TECHNOLOGY

The present disclosure relates generally to the field of computer technologies and, more particularly to a page browsing method and browser in a mobile device.

### BACKGROUND

At present, wide screen displays have become the development trend and along with the gradual improvement of the processing capacity of computers, tasks that can be run simultaneously by operating systems are increasing. In the Windows 8 preview version already released, multitask functions (such as dragging and snapping to display application) can be supported. When operating, it is only necessary to hang the mouse cursor to the left fringe of the screen and the application being run will automatically appear. The mouse cursor is then held to drag an application window from the left to the right, at which time it is visible that the application window thumbnail grows from small to big and eventually forms multiple application window snapped displays.

This multitask display mode is convenient for operation and enhances user experience, but displaying multiple application windows on a limited screen results in the reduction of the display area of each application window. A browser is an essential application for a user to go online, and it displays various formats (such as HTML (Hyper Text Markup Language)) of structured language files and image data files acquired from a server as the contents. In the case of simultaneous display of multiple application windows, to increase the displayed content of the browser as much as possible, there are usually two ways to achieve optimization:

(1) Increase the screen size and screen resolution. This is the most effective way as more content can be displayed with a larger screen size and greater space can be provided with higher resolution, and the displayed view of the application will not be reduced or incomplete. However, this method requires the support of hardware and increases user cost.

(2) Optimize the display area of the browser. The interface of a browser usually comprises a status bar, a menu bar, a tool bar, a title bar, an address bar and a display area. The title bar is usually permanent and located at the top of the browser, while the status bar, the menu bar and the tool bar are infrequently used function bars. Therefore, the infrequently used function bars, such as the status bar, the menu bar and the tool bar, may be set to hidden before page browsing, and this helps to increase the displayed content of the display area somewhat.

But for the address bar, while it can be set to hidden by most browser, a user must input the respective web address into the address bar each time the user wishes to browse a webpage, and manually setting the display status of the address bar repeatedly is troublesome. Therefore, the address bar is often set to show permanently on the browser interface, and this affects the maximization of the display area and restricts user experience to a certain extent.

### BRIEF SUMMARY

The present disclosure aims at providing a page browsing method and browser to overcome the problems associated with inconvenience of setting existing browser address bars to hidden.

The present disclosure provides a page browsing method including: loading page data; displaying page in the browsing area of a browser interface; monitoring user events of the browser interface; and setting the address bar to hidden upon identifying a first action message at the time when the user is browsing the page content.

The present disclosure further provides a browser including: a loading unit for loading page data; a drawing unit for displaying the page in the browsing area of the browser interface; a monitoring unit for monitoring user events of the browser interface; and a hide control unit for setting the address bar to hidden upon the monitoring unit identifying a first action message at the time when the user is browsing the page content.

The present disclosure further provides a mobile device including a processor and a display controlled by the processor. The processor is configured to: load data to be displayed in a real time communication application; display, on the display, a page based on the loaded data in a browsing area of a user interface of the real time communication application, the user interface comprising an address bar; monitor user events of the user interface; and hide at least part of the address bar to increase the browsing area upon identifying a first action message at the time when the user is browsing the page.

In comparison with the prior art, the present disclosure has the beneficial effects that it effectively increases user's browsing area and maximizes the browsing area on the interface through automatic control of show/hide of the browser address bar without affecting user's utility, thereby enhancing user experience. The present disclosure is suitable for operating systems supporting simultaneous display of multi-applications and for terminal equipment whose screens are getting increasingly slender.

The foregoing is only a brief summary of the solutions of the present disclosure. For a better understanding of the solutions, the aforementioned and other objectives, characteristics and advantages of the present disclosure, preferred embodiments thereof are described in detail in connection with the accompanying drawings as follows.

### BRIEF DESCRIPTION OF THE DRAWINGS

FIG. 1 is a process flow diagram of a page browsing method of an embodiment of the present disclosure.

FIG. 2 is a process flow diagram of another page browsing method of an embodiment of the present disclosure.

FIG. 3 is a schematic diagram of a browser interface in an embodiment of the present disclosure.

FIG. 4 is a schematic diagram of a browser of an embodiment of the present disclosure.

FIG. 5 is a schematic diagram of another browser of an embodiment of the present disclosure.

FIG. 6 is an example embodiment of a mobile device of the present disclosure.

### DETAILED DESCRIPTION OF THE EMBODIMENTS

To better illustrate the solutions adopted for the purpose of achieving the intended objectives of the present disclosure and the effects thereof, preferred embodiments of the page browsing method and browser provided by the present disclosure are described below in detail.

The foregoing and other content, characteristics and effects of the present disclosure are clearly presented in the preferred embodiments in connection with the accompanying drawings. The means adopted for the purpose of achieving the intended objectives of the present disclosure and the effects thereof will be better understood through the detailed description. The accompanying drawings are only intended for reference and shall not be construed as limiting the scope of the present disclosure.

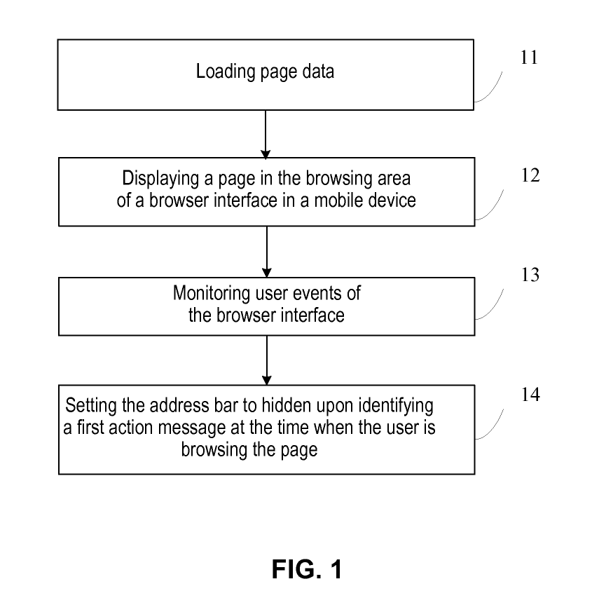

Referring to FIG. 1, which is a process flow diagram of a page browsing method of an embodiment of the present disclosure, the page browsing method comprising the following steps:

S11—loading page data.

After inputting a website address into the address bar, the user will acquire text data and image data in various formats, such as HTML (Hyper Text Markup Language) format. Other data may be loaded to shown on the interface. Such data may include contacts data, shared data, or any other data in a social network.

S12—displaying page in the browsing area of a browser interface.

The browser will display renders of the text data and image data acquired from the web in the browsing area of the browser interface. As the browser loads the page, the address bar is set to show in order to display to the user the website address currently being loaded.

S13—monitoring user events of the browser interface.

After loading the page, the browsing area displays the page content at which time the browser is able to monitor the browser interface, including various user actions or events of status change occurred on the interface and identifiable by the browser, such as mouse cursor or keyboard operation, page status change, etc.

S14—setting the address bar to hidden upon identifying a first action message at the time when the user is browsing the page content.

The aforementioned first action message refers to the action message identified by the browser about the action that may be taken by the user when browsing the page content. A preferred first action message of the present disclosure is an action message identified by the browser about sliding up the page (i.e. action message about browsing the page from the top downward). Specifically, when the browser identifies the event of sliding up the page, it will generate a corresponding event object according to the acquired first action message, the event object comprising the corresponding parameter value of the action, and control over the command control of the address bar will then be triggered according to the event object and the address bar will be set to hidden. In this way, when the user browses the page content the browser will automatically hide the address bar and allocate the space originally occupied by the address bar to the browsing area, thereby maximizing the browsing area on the interface, providing convenience for reading of page content and enhancing user experience.

It must be noted that the first action message is not limited to action message identified by the browser when the page is slid up, and may be set according to need, e.g. the page is not operated within a period of time, the mouse cursor selects certain content of the page, the mouse wheel rotates, the downward arrow key on the keyboard is clicked, text is input into text box of the page, a double-click on the page, etc. All these may be recognized as the user browsing the page content, and action message identified by the browser based on these events may also be taken as first action message to be the trigger condition for hiding the address bar.

When setting the address bar to hidden, some hidden effects of the address bar may be set through programmed control to enhance user experience. For example, the bottom of the address bar and the top of the page may be configured to be always superimposed upon each other (this can be achieved by setting the position coordinates of both endpoints of the bottom of the address bar to be the same as the position coordinates of both endpoints of the top of the page) such that the user will experience that when the page is slid up by the user, the address bar is pushed away from the top of the browsing area together with the top of the page that has been browsed; or the address bar may be set to gradually become transparent and disappear, or set in combination with sound effects.

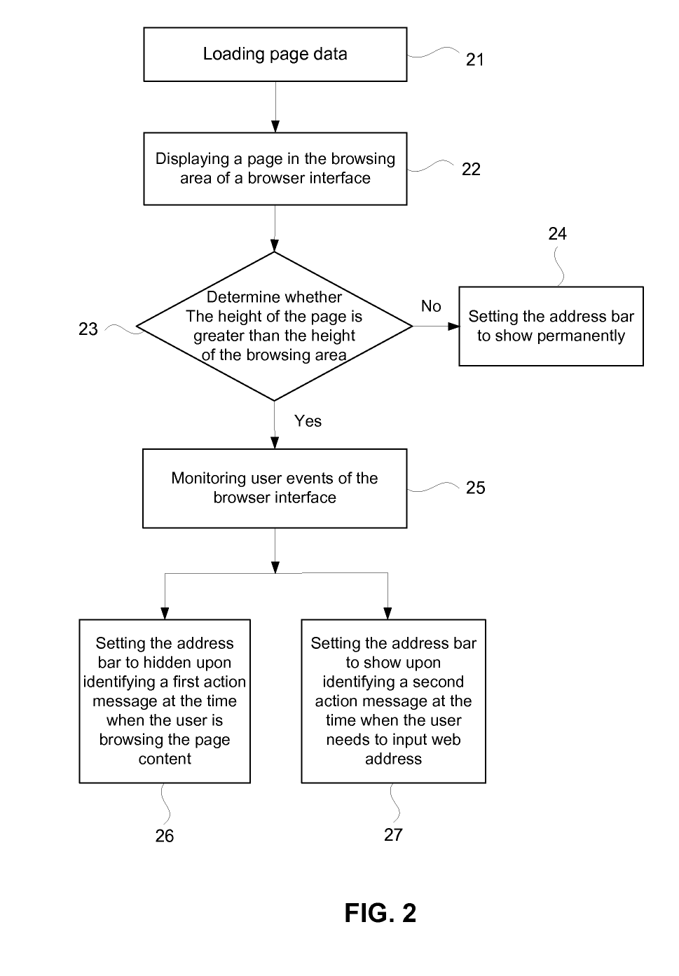

Referring to FIG. 2, which is a process flow diagram of another page browsing method of an embodiment of the present disclosure, the page browsing method comprising the following steps:

S21—loading page data.

As the browser loads the page, the address bar is set to show in order to display to the user the website address currently being loaded.

S22—displaying a page in the browsing area of a browser interface.

S23—determining whether the height of the page is greater than the height of the browsing area.

S24—setting the address bar to show permanently if the height of the page is less than or equal to the height of the browsing area. Proceed to subsequent step if the height of the page is greater than the height of the browsing area.

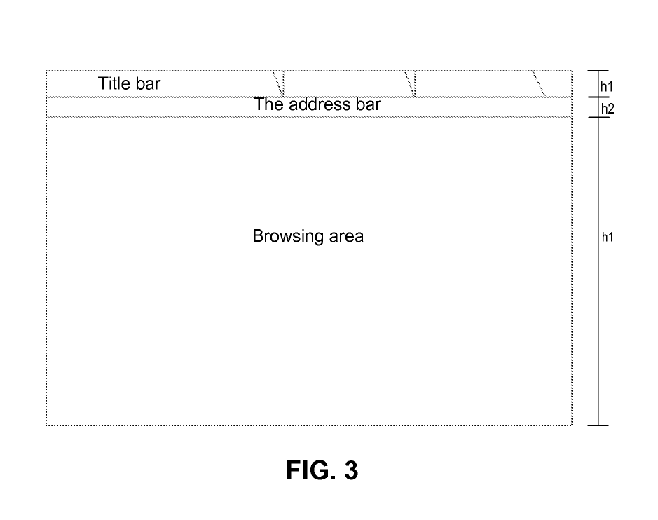

FIG. 3 is a schematic diagram of a browser interface in an embodiment of the present disclosure. The browser interface may be a part of a real time communication application. For example, the real time communication application may be used as a messenger in a social network. When users of the messenger update their status, they may share webpages using a Hypertext Transfer Protocol (HTTP) link such that the other users can browse the webpage related to the link. Users may use other ways to share webpages that is known in the art. The data to be displayed in the browser interface may include any data in the social network application. The data may include contacts data, user information, user contributed content, any information related to the user in the social network, or any information the user may be interested in. The data may also include ads, blogs, or other information the user choose.

In FIG. 3, the address bar is shown and the height of the title bar is h1, the height of the address bar is h2 and the height of the browsing area is h4. If the address bar is set to hidden, then the height of the browsing area may be increased to h2+h4. Therefore, when the address bar is shown and the height of the page is less than the height of the browsing area, the content of the page can be completely displayed in the browsing area with a height of h2, and browsing will not be affected and it is not necessary to set the address bar to hidden. On the contrary, if the height of the page is greater than the height of the browsing area h2, then it is necessary to enlarge the browsing area to display more page content.

S25—monitoring user events of the browser interface.

After loading the page, the browsing area displays the page content at which time the browser is able to monitor the browser interface, including various user actions or events of status change occurred on the interface and identifiable by the browser, such as mouse cursor or keyboard operation, page status change, etc.

S26—setting the address bar to hidden upon identifying a first action message at the time when the user is browsing the page content.

The aforementioned first action message refers to the action message identified by the browser about the action that may be taken by the user when browsing the page content. A preferred first action message of the present disclosure is an action message identified by the browser about sliding up the page (i.e. action message about browsing the page from the top downward).

S27—setting the address bar to show upon identifying a second action message at the time when the user needs to input web address.

The aforementioned second action message refers to the action message identified by the browser about the action that may be taken by the user at the time when the user needs to input web address. A preferred second action message of the present disclosure is a message about the browser interface title bar or status message about the top of the page entering the browsing area. Specifically, when the browser identifies the event of the title bar being clicked by the mouse curser or the event of the page being slid downward to the top (i.e. the top of the page entering the browsing area), it will generate a corresponding event object according to the acquired second action message, the event object comprising the corresponding parameter value of the action, and control over the command control of the address bar will then be triggered according to the event object and the address bar will be set to show. In this way, when the user needs to input web address the browser will automatically show the address bar to facilitate convenient operation.

Of course, the second action message is not limited to action message identified by the browser about clicking of the title bar and when the page is slid up, and may be set according to need, e.g. clicking of the return key of the keyboard may also be taken as second action message to be the trigger condition for showing the address bar.

When setting the address bar to show, some show effects of the address bar may be set through programmed control to enhance user experience. For example, the bottom of the address bar and the top of the page may be configured to be always superimposed upon each other (this can be achieved by setting the position coordinates of both endpoints of the bottom of the address bar to be the same as the position coordinates of both endpoints of the top of the page) such that the user will experience that when the page is slid up by the user, the top of the browsing area is pulled from the browsing area together with the address bar; or the address bar may be set to gradually become transparent and shown, or set in combination with sound effects.

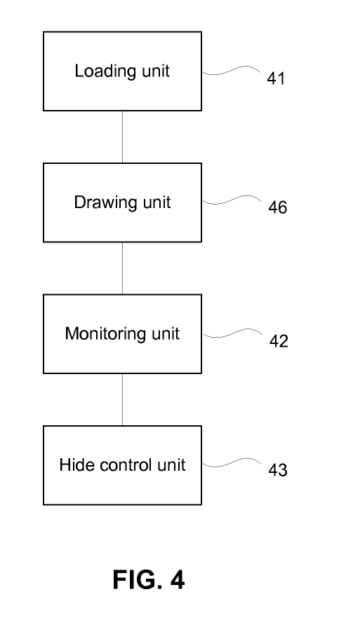

The present disclosure further provides a browser as shown in FIG. 4. The browser may be implemented in a software that runs in a mobile device such as a smartphone, a tablet, or any other computing devices having a processor, a non-transitory storage medium accessible to the processor, and a display screen controlled by the processor. The browser comprises a loading unit 41, a drawing unit 46, a monitoring unit 42, a hide control unit 43. The drawing unit 46 is connected to the loading unit 41, the monitoring unit is connected to the drawing unit 46, and the hide control unit 43 and the show control unit 44 are connected to the monitoring unit 42 respectively.

When the browser is in use, page data is acquired from the website, loaded by the loading unit 41 and displayed by the drawing unit 46 in the browsing area of the browser interface. During the process of loading page data, the address bar is set to show in order to display to the user the website address currently being loaded.

After loading the page, the monitoring unit 42 acquires loaded signal from the drawing unit 46 and begins to monitor user events of the browser interface, including various user actions or events of status change occurred on the interface and identifiable by the browser, such as mouse cursor or keyboard operation, page status change, etc.

Upon identifying a first action message at the time when the user is browsing the page content, the monitoring unit 42 sends a control signal to the hide control unit 43, and the address bar is set to hidden by the hide control unit 43. The aforementioned first action message refers to the action message identified by the monitoring unit 4 about the action that may be taken by the user when browsing the page content. A preferred first action message of the present disclosure is an action message identified by the monitoring unit 42 about sliding up the page. Specifically, when the monitoring unit 42 identifies the event of sliding up the page, it will generate a corresponding event object according to the acquired first action message, the event object comprising the corresponding parameter value of the action, and the hide control unit 43 will then trigger control over the command control of the address bar according to the event object and set the address bar to hidden. In this way, when the user browses the page content the browser will automatically hide the address bar and allocate the space originally occupied by the address bar to the browsing area, thereby maximizing the browsing area on the interface, providing convenience for reading of page content and enhancing user experience.

It must be noted that the first action message is not limited to action message identified by the monitoring unit 42 when the page is slid up, and may be set according to need, e.g. the page is not operated within a period of time, the mouse cursor selects certain content of the page, the mouse wheel rotates, the downward arrow key on the keyboard is clicked, text is input into text box of the page, etc. All these may be recognized as the user browsing the page content, and action message identified by the monitoring unit 42 based on these events may also be taken as first action message to be the trigger condition for hiding the address bar.

When setting the address bar to hidden, some hidden effects of the address bar may be set through programmed control to enhance user experience. For example, the bottom of the address bar and the top of the page may be configured to be always superimposed upon each other (this can be achieved by setting the position coordinates of both endpoints of the bottom of the address bar to be the same as the position coordinates of both endpoints of the top of the page) such that the user will experience that when the page is slid up by the user, the address bar is pushed away from the top of the browsing area together with the top of the page that has been browsed; or the address bar may be set to gradually become transparent and disappear, or set in combination with sound effects.

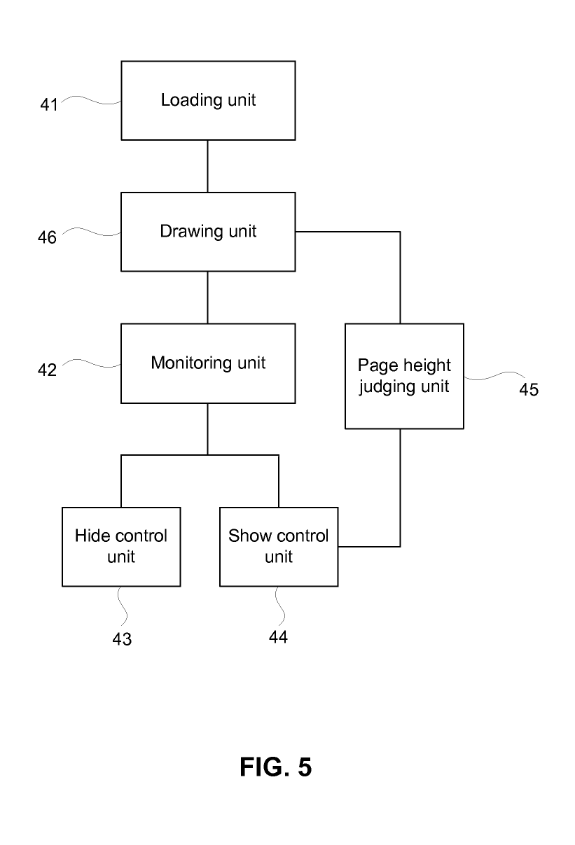

Referring to FIG. 5, which is a schematic diagram of another browser of an embodiment of the present disclosure. The browser comprises a loading unit 41, a drawing unit 46, a monitoring unit 42, a hide control unit 43, a show control unit 44 and a page height determining unit 45. The drawing unit 46 is connected to the loading unit 41, the monitoring unit 42 is connected to the drawing unit 46, the monitoring unit 42 is connected to the drawing unit 46, the hide control unit 43 and the show control unit 44 are connected to the monitoring unit 42 respectively, and the page height determining unit 45 is connected to the drawing unit 46 and the show control unit 44 respectively.

Compared to the embodiment of FIG. 4, this embodiment is added with a page height determining unit 45 and a show control unit 44. The page height determining unit 45 is used for determining whether the height of the loaded page is greater than the height of the browsing area. If the height of the page is less than or equal to the height of the browsing area, then the address bar is set to show permanently by the show control unit 44. Upon the monitoring unit 42 identifying a first action message at the time when the user is browsing the page content, the hide control unit 43 will first determine whether the address bar is set to show permanently. If the address bar is set to show permanently, no operation will be performed; and if the address bar is not set to show permanently, the address bar will be set to hidden.

Referring to FIG. 3, the address bar is shown and the height of the title bar is h1, the height of the address bar is h2 and the height of the browsing area is h4. If the address bar is set to hidden, then the height of the browsing area may be increased to h2+h4. Therefore, when the address bar is shown and the height of the page is less than the height of the browsing area, the content of the page can be completely displayed in the browsing area with a height of h2, and browsing will not be affected and it is not necessary to set the address bar to hidden. Hence, the address bar may be set to show permanently through the show control unit 44. On the contrary, if the height of the page is greater than the height of the browsing area h2, then it is necessary to enlarge the browsing area to display more page content.

The function of the show control unit 44 is as follows: upon the monitoring unit 42 identifying a second action message at the time when the user needs to input web address, the monitoring unit 42 sends a control signal to the show control unit 44, and the show control unit 44 sets the address bar to show. The aforementioned second action message refers to the action message identified by the monitoring unit 42 about the action that may be taken by the user at the time when the user needs to input web address. A preferred second action message of the present disclosure is a message about clicking of the title bar or status message about the top of the page entering the browsing area. Specifically, when the monitoring unit 42 identifies the event of the title bar being clicked by the mouse curser or the event of the page being slid downward to the top (i.e. the top of the page entering the browsing area), it will generate a corresponding event object according to the acquired second action message, the event object comprising the corresponding parameter value of the action, and control over the command control of the address bar will then be triggered by the show control unit 44 according to the event object and the address bar will be set to show. In this way, when the user needs to input web address the browser will automatically show the address bar to facilitate convenient operation.

Of course, the second action message is not limited to action message identified by the browser about clicking of the title bar and when the page is slid up, and may be set according to need, e.g. clicking of the return key of the keyboard may also be taken as second action message to be the trigger condition for showing the address bar.

When setting the address bar to show, some show effects of the address bar may be set through programmed control to enhance user experience. For example, the bottom of the address bar and the top of the page may be configured to be always superimposed upon each other (this can be achieved by setting the position coordinates of both endpoints of the bottom of the address bar to be the same as the position coordinates of both endpoints of the top of the page) such that the user will experience that when the page is slid up by the user, the top of the browsing area is pulled from the browsing area together with the address bar; or the address bar may be set to gradually become transparent and shown, or set in combination with sound effect.

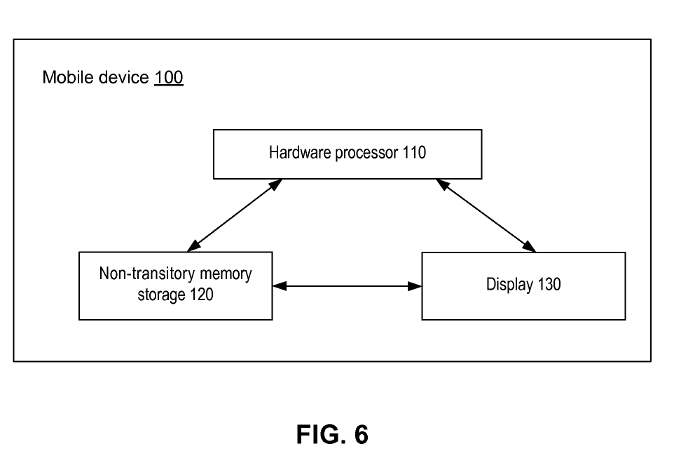

The method, browser, and interface disclosed in the disclosure may be implemented in any mobile device having a processor and a non-transitory memory storage accessible to the processor. FIG. 6 shows an example embodiment of a mobile device 100 including a processor 110, a non-transitory memory storage 120, and a display 130. The processor 110 is configured to read and write data to the non-transitory memory storage 120. The processor 110 is further configured to receive inputs from the display 130 and control the content to be displayed in the display 130.

The present disclosure effectively increases user's browsing area and maximizes the browsing area on the interface through automatic control of show/hide of the browser address bar without affecting user's utility, thereby enhancing user experience. The present disclosure is suitable for operating systems supporting simultaneous display of multi-applications and for terminal equipment whose screens are getting increasingly slender.

While the present disclosure has been disclosed in connection with preferred embodiments thereof, it should be understood that those preferred embodiments are not intended to limit the scope of the present disclosure and that those with ordinary skill in the art should be able to make various modifications and variations without departing from the spirit and scope of the present disclosure. Hence, any equivalent embodiments shall fall within the scope of the present disclosure.

What is claimed is:

1. A page browsing method, comprising:
loading, by a computing device having a processor and a display, page data;
displaying a page in the browsing area of a browser interface on the display;
monitoring user events of the browser interface; and
setting the address bar to hidden upon identifying a first action message at the time when the user is browsing the page.

2. The method of claim 1, further comprising:
setting the address bar to show upon identifying a second action message at the time when the user needs to input web address.

3. The method of claim 1, further comprising:
determining whether the height of the page is greater than the height of the browsing area;
setting the address bar to show permanently if the height of the page is less than or equal to the height of the browsing area.

4. The method of claim 1, wherein setting the address bar to hidden upon identifying a first action message at the time when the user is browsing the page comprises:
determining whether the address bar shows permanently upon identifying a first action message at the time when the user is browsing the page content; and
setting the address bar to hidden if the address bar does not show permanently.

5. The method of claim 1, wherein the first action message comprises message to slide up the page.

6. The method of claim 1, wherein the second action message comprises message to click the browser interface title bar or state message about the top of the page entering the browsing area.

7. A non-transitory storage medium accessible to a processor, the non-transitory storage medium comprising:
a loading unit that loads page data;
a drawing unit that displays a page in a browsing area of the browser interface, the browser interface having an address bar;
a monitoring unit that monitors user events of the browser interface; and
a hide control unit that sets the address bar to hidden upon the monitoring unit identifying a first action message at the time when the user is browsing the page.

8. The non-transitory storage medium of claim 7, further comprising:
a show control unit that sets the address bar to show upon the monitoring unit identifying a second action message at the time when the address bar needs to be shown.

9. The non-transitory storage medium of claim 7, further comprising:
a page height determining unit that determines whether the height of the page is greater than the height of the browsing area, and setting the address bar to show permanently if the height of the page is less than or equal to the height of the browsing area;
the hide control unit determining whether the address bar shows permanently upon the monitoring unit identifying a first action message at the time when the user is browsing the page, and setting the address bar to hidden if the address bar does not show permanently.

10. The non-transitory storage medium of claim 7, wherein that the first action message comprises message to slide up the page.

11. The non-transitory storage medium of claim 7, wherein that the second action message comprises message to click the browser interface title bar or state message about the top of the page entering the browsing area.

12. A mobile device comprising a processor and a display controlled by the processor, the processor is configured to:
load data to be displayed in a real time communication application;
display, on the display, a page based on the loaded data in a browsing area of a user interface of the real time communication application, the user interface comprising an address bar;
monitor user events of the user interface; and
hide at least part of the address bar to increase the browsing area upon identifying a first action message at the time when the user is browsing the page.

13. The mobile device of claim 12, wherein the data to be displayed comprise contacts data in a social network application.

14. The mobile device of claim 12, wherein the loaded data comprises social updates information in the real time communication application.

15. The mobile device of claim 12, wherein the first action comprises double-click by fingers or other devices.

16. The mobile device of claim 12, wherein the first action is preset by a user.
